(19) United States
(12) Patent Application Publication
(10) Pub. No.: US 2014/0369394 A1
(43) Pub. Date: Dec. 18, 2014

(54) BEAM-STEERING CONFIGURATIONS AND TESTS

(71) Applicants: Paivi Ruuska, Kristiansand (FI); Jarkko Kneckt, Espoo (FI); Ari Hottinen, Espoo (FI)

(72) Inventors: Paivi Ruuska, Kristiansand (FI); Jarkko Kneckt, Espoo (FI); Ari Hottinen, Espoo (FI)

(73) Assignee: Nokia Corporation, Espoo (FI)

(21) Appl. No.: 14/345,650

(22) PCT Filed: Sep. 21, 2011
(86) PCT No.: PCT/IB2011/054153

§ 371 Date: Jun. 30, 2014

(51) Int. Cl. H04W 16/28; H04B 17/00

(52) U.S. Cl. CPC H04W 16/28; H04B 17/00
USPC 375/224

(57) ABSTRACT

An apparatus, method and system for beam-steering configurations and tests in a communication system. In one embodiment, the apparatus includes a processor 620 and memory 650 including computer program code. The memory 650 and the computer program code are further configured to, with the processor 620, cause the apparatus to receive a beam-steering test configuration from a serving network element in response to a request for a beam-steering test with a network element, and perform the beam-steering test with the network element in the beam-steering test configuration.

### TECHNICAL FIELD

The present invention is directed, in general, to communication systems and, in particular, to an apparatus, method and system for beam-steering configurations and tests in a communication system.

### BACKGROUND

Long term evolution (“LTE”) of the Third Generation Partnership Project (“3GPP”), also referred to as 3GPP LTE, refers to research and development involving the 3GPP LTE Release 8 and beyond as part of an ongoing effort across the industry aimed at identifying technologies and capabilities that can improve systems such as the universal mobile telecommunication system (“UMTS”). The notation “LTE-A” is generally used in the industry to refer to further advancements in LTE. The goals of this broadly based project include improving communication efficiency, lowering costs, improving services, making use of new spectrum opportunities, and achieving better integration with other open standards.

The evolved universal terrestrial radio access network (“E-UTRAN”) in 3GPP includes base stations providing user plane (including packet data convergence protocol/radio link control/media access control/physical (“PDCP/RLC/MAC/PHY”) sublayers) and control plane (including radio resource control (“RRC”) sublayer) protocol terminations towards wireless communication devices such as cellular telephones. A wireless communication device or terminal is generally known as user equipment (also referred to as “UE”). A base station (“BS”) is an entity or network element of a communication system or network often referred to as a Node B or an NB. Particularly in the E-UTRAN, an “evolved” base station is referred to as an eNodeB or an eNB. For details about the overall architecture of the E-UTRAN, see 3GPP Technical Specification (“TS”) 36.300 v8.7.0 (2008-12), which is incorporated herein by reference. For details of the radio resource control management, see 3GPP TS 25.331 v.9.1.0 (2009-12) and 3GPP TS 36.331 v.9.1.0 (2009-12), which are incorporated herein by reference.

Beam steering is a functionality that can adversely affect communication link capacity of high-throughput radios. Distortions caused by simultaneous transmissions between communication devices or elements in the same geographical area with poorly managed beam steering directly impact communication link performance. Present approaches to manage antenna beam widths and directions do not take into account the needs and preferences of communication devices such as user equipment that may encounter localized communication issues.

As wireless communication systems such as cellular telephone, satellite, and microwave communication systems become widely deployed and continue to attract a growing number of users, there is a pressing need to efficiently accommodate a large and variable number of communication devices that operate concurrently in a limited geographical area such as the limited cellular area served by a serving network element or base station. A consequence of poorly managed communication resources such as antenna beam widths and directions is interference between communication devices such as user equipments and base stations.

Thus, management of antenna beam widths and directions has become a fundamental unresolved issue in communication systems with limited communication resources that accommodate the large number of simultaneous and closely spaced communication devices in a limited range of spectrum. Improved management of antenna beam widths and directions while taking into account the needs and preferences of communication devices such as user equipment in the communication system would address an unanswered market need.

### SUMMARY OF THE INVENTION

These and other problems are generally solved or circumvented, and technical advantages are generally achieved, by embodiments of the present invention, which include an apparatus, method and system for beam-steering configurations and tests in a communication system. In one embodiment, the apparatus includes a processor and memory including computer program code. The memory and the computer program code are further configured to, with the processor, cause the apparatus to receive a beam-steering test configuration from a serving network element in response to a request for a beam-steering test with a network element, and perform the beam-steering test with the network element in the beam-steering test configuration.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate system level diagrams of embodiments of communication systems including a base station and wireless communication devices that provide an environment for application of the principles of the present invention;

FIGS. 3 to 5 illustrate system level diagrams of embodiments of communication systems including wireless communication systems that provide an environment for application of the principles of the present invention;

FIG. 6 illustrates a system level diagram of an embodiment of a communication element of a communication system for application of the principles of the present invention;

FIGS. 7 and 8 illustrate representations of an embodiment of a user equipment communicating with a network element that results in a handover of the user equipment to another network element after communication of a beam-steering constraint in accordance with the principles of the present invention;

FIGS. 9 and 10 illustrate representations of an embodiment of a user equipment communicating with the serving network element to a perform beam-steering test in accordance with a beam-steering test configuration according to the principles of the present invention; and

FIGS. 11 and 12 illustrate flow diagrams of embodiments of operating a user equipment and a serving network element, respectively, according to the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context of an apparatus, method and system for beam-steering configurations and tests in a communication system. In accordance therewith, the apparatus provides for the management of antenna beam widths and directions while taking into account the needs and preferences of communication elements of devices in a communication system such that ones of the communication devices (such as a user equipment) can signal constraints or preferences to a other communication devices (such as a base station or an access point) to enable efficient beam steering, thereby advantageously reducing interference between the communication devices. The apparatus, method and system are applicable, without limitation, to any communication system including existing and future cellular technologies including 3GPP technologies (i.e., UMTS, LTE, and future variants such as 4th generation (“4G”) communication systems) and a wireless local area network (“WLAN”) operable under IEEE standard 802.11 (or a worldwide interoperability for microwave access (“WiMAX”) communication system operable under IEEE standard 802.16). Additionally, WLAN communications, communication systems, modules, modes or the like generally include non-cellular equivalents such as, without limitation, technologies related to WiMAX, WiFi, industrial, scientific and medical (“ISM”), global positioning system (“GPS”) and Bluetooth.

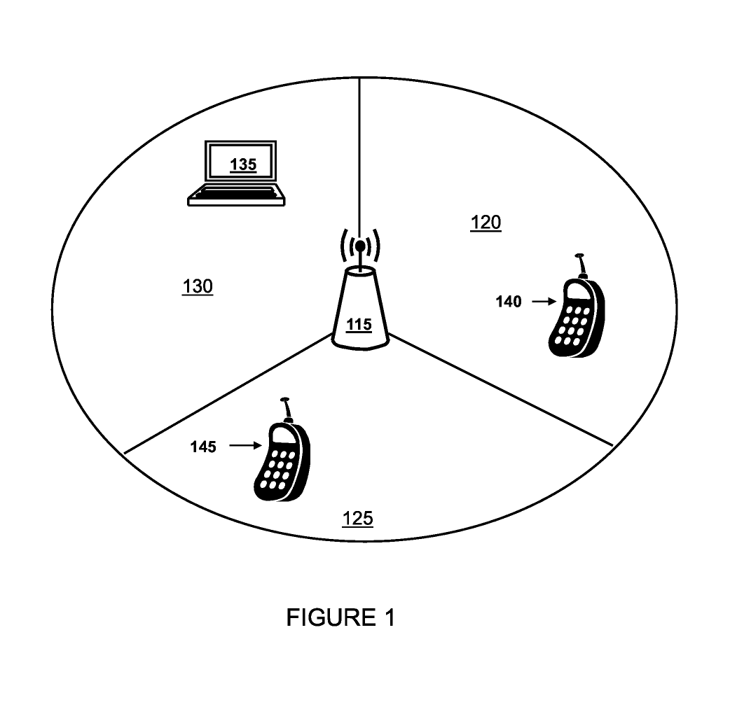

Turning now to FIG. 1, illustrated is a system level diagram of an embodiment of a communication system including a base station 115 and wireless communication devices (e.g., user equipment) 135, 140, 145 that provides an environment for application of the principles of the present invention. The base station 115 is coupled to a public switched telephone network (not shown). The base station 115 is configured with a plurality of antennas to transmit and receive signals in a plurality of sectors including a first sector 120, a second sector 125, and a third sector 130, each of which typically spans 120 degrees. Although FIG. 1 illustrates one wireless communication device (e.g., wireless communication device 140) in each sector (e.g. the first sector 120), a sector (e.g. the first sector 120) may generally contain a plurality of wireless communication devices. In an alternative embodiment, a base station 115 may be formed with only one sector (e.g. the first sector 120), and multiple base stations may be constructed to transmit according to co-operative multi-input/multi-output (“C-MIMO”) operation, etc.

The sectors (e.g. the first sector 120) are formed by focusing and phasing radiated signals from the base station antennas, and separate antennas may be employed per sector (e.g. the first sector 120). The plurality of sectors 120, 125, 130 increases the number of subscriber stations (e.g., the wireless communication devices 135, 140, 145) that can simultaneously communicate with the base station 115 without the need to increase the utilized bandwidth by reduction of interference that results from focusing and phasing base station antennas. While the wireless communication devices 135, 140, 145 are part of a primary communication system, the wireless communication devices 135, 140, 145 and other devices such as machines (not shown) may be a part of a secondary communication system to participate in, without limitation, device-to-device and machine-to-machine communications or other communications.

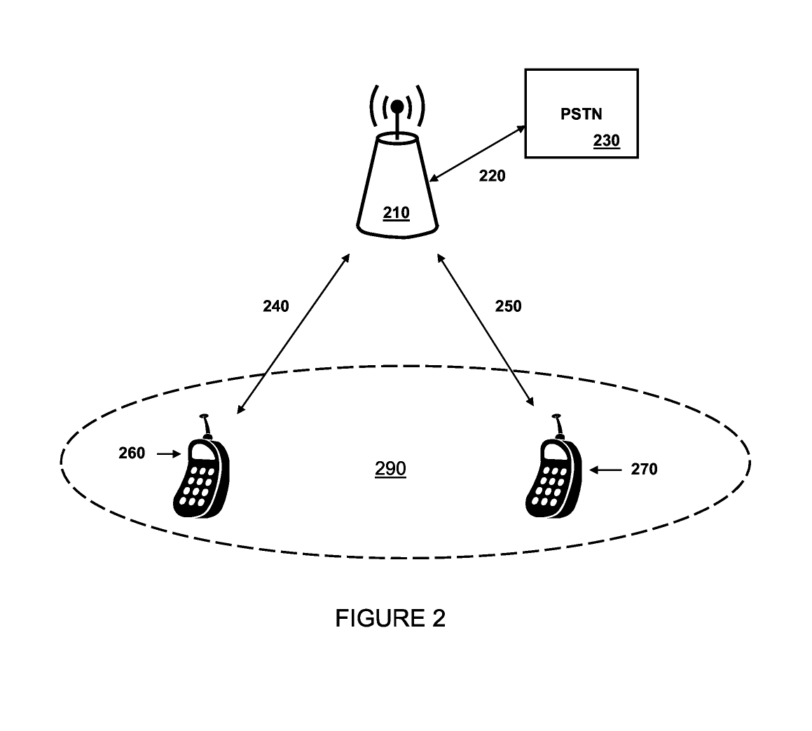

Turning now to FIG. 2, illustrated is a system level diagram of an embodiment of a communication system including a base station 210 and wireless communication devices (e.g., user equipment) 260, 270 that provides an environment for application of the principles of the present invention. The communication system includes the base station 210 coupled by communication path or link 220 (e.g., by a fiber-optic communication path) to a core telecommunications network such as public switched telephone network (“PSTN”) 230. The base station 210 is coupled by wireless communication paths or links 240, 250 to the wireless communication devices 260, 270, respectively, that lie within its cellular area 290.

In operation of the communication system illustrated in FIG. 2, the base station 210 communicates with each wireless communication device 260, 270 through control and data communication resources allocated by the base station 210 over the communication paths 240, 250, respectively. The control and data communication resources may include frequency and time-slot communication resources in frequency division duplex (“FDD”) and/or time division duplex (“TDD”) communication modes. While the wireless communication devices 260, 270 are part of a primary communication system, the wireless communication devices 260, 270 and other devices such as machines (not shown) may be a part of a secondary communication system to participate in, without limitation, device-to-device and machine-to-machine communications or other communications.

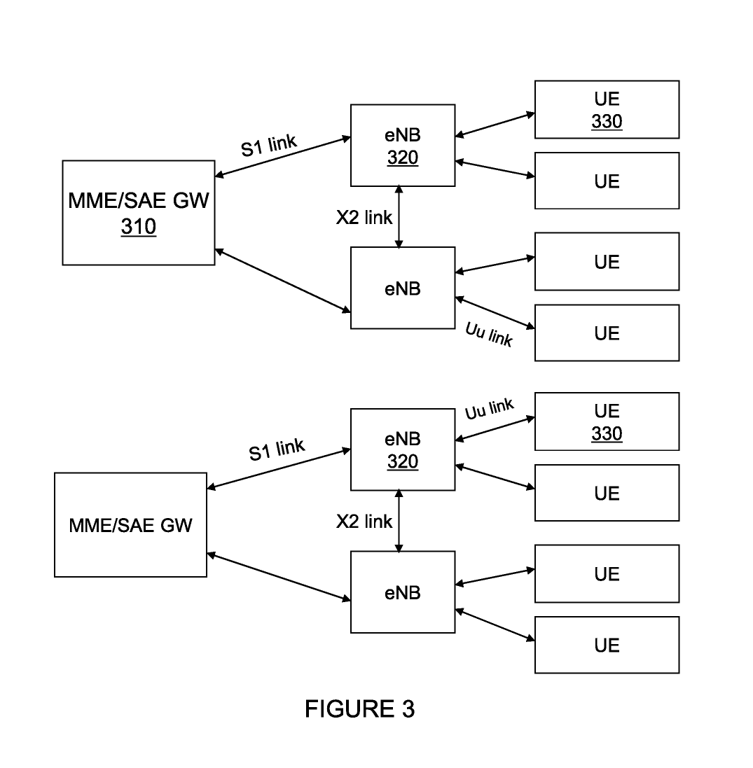

Turning now to FIG. 3, illustrated is a system level diagram of an embodiment of a communication system including a wireless communication system that provides an environment for the application of the principles of the present invention. The wireless communication system may be configured to provide evolved UMTS terrestrial radio access network (“E-UTRAN”) universal mobile telecommunications services. A mobile management entity/system architecture evolution gateway (“MME/SAE GW,” one of which is designated 310) provides control functionality for an E-UTRAN node B (designated “eNB,” an “evolved node B,” also referred to as a “base station,” one of which is designated 320) via an S1 communication link (ones of which are designated “S1 link”). The base stations 320 communicate via X2 communication links (ones of which are designated “X2 link”). The various communication links are typically fiber, microwave, or other high-frequency metallic communication paths such as coaxial links, or combinations thereof.

The base stations 320 communicate with wireless communication devices such as user equipment (“UE,” ones of which are designated 330), which is typically a mobile transceiver carried by a user. Thus, communication links (designated “Uu” communication links, ones of which are designated “Uu link”) coupling the base stations 320 to the user equipment 330 are air links employing a wireless communication signal such as, for example, an orthogonal frequency division multiplex (“OFDM”) signal. While the user equipment 330 are part of a primary communication system, the user equipment 330 and other devices such as machines (not shown) may be a part of a secondary communication system to participate in, without limitation, device-to-device and machine-to-machine communications or other communications.

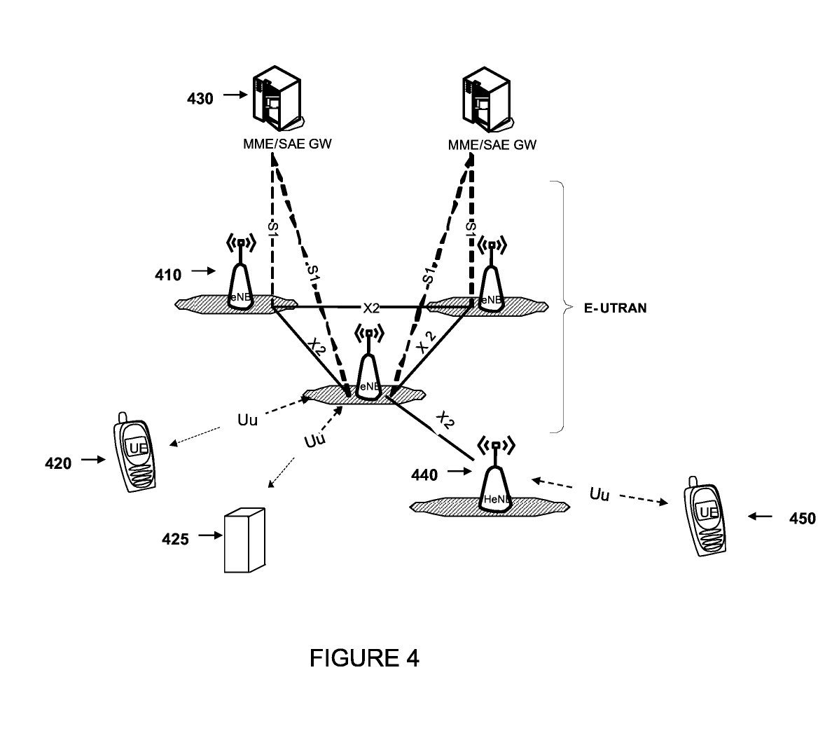

Turning now to FIG. 4, illustrated is a system level diagram of an embodiment of a communication system including a wireless communication system that provides an environment for the application of the principles of the present invention. The wireless communication system provides an E-UTRAN architecture including base stations (one of which is designated 410) providing E-UTRAN user plane (packet data convergence protocol/radio link control/media access control/physical) and control plane (radio resource control) protocol terminations towards wireless communication devices such as user equipment 420 and other devices such as machines 425 (e.g., an appliance, television, meter, etc.). The base stations 410 are interconnected with X2 interfaces or communication links (designated “X2”). The base stations 410 are also connected by S1 interfaces or communication links (designated “S1”) to an evolved packet core (“EPC”) including a mobile management entity/system architecture evolution gateway (“MME/SAE GW,” one of which is designated 430). The S1 interface supports a multiple entity relationship between the mobile management entity/system architecture evolution gateway 430 and the base stations 410. For applications supporting inter-public land mobile handover, inter-eNB active mode mobility is supported by the mobile management entity/system architecture evolution gateway 430 relocation via the S1 interface.

The base stations 410 may host functions such as radio resource management. For instance, the base stations 410 may perform functions such as internet protocol (“IP”) header compression and encryption of user data streams, ciphering of user data streams, radio bearer control, radio admission control, connection mobility control, dynamic allocation of communication resources to user equipment in both the uplink and the downlink, selection of a mobility management entity at the user equipment attachment, routing of user plane data towards the user plane entity, scheduling and transmission of paging messages (originated from the mobility management entity), scheduling and transmission of broadcast information (originated from the mobility management entity or operations and maintenance), and measurement and reporting configuration for mobility and scheduling. The mobile management entity/system architecture evolution gateway 430 may host functions such as distribution of paging messages to the base stations 410, security control, termination of user plane packets for paging reasons, switching of the user plane for support of the user equipment mobility, idle state mobility control, and system architecture evolution bearer control. The user equipment 420 and machines 425 receive an allocation of a group of information blocks from the base stations 410.

Additionally, the ones of the base stations 410 are coupled to a home base station 440 (a device), which is coupled to devices such as user equipment 450 and/or machines (not shown) for a secondary communication system. The base station 410 can allocate secondary communication system resources directly to the user equipment 420 and machines 425, or to the home base station 440 for communications (e.g., local communications) within the secondary communication system. For a better understanding of home base stations (designated “HeNB”), see 3 GPP TS 32.871 v.9.1.0 (2010-03), which is incorporated herein by reference. While the user equipment 420 and machines 425 are part of a primary communication system, the user equipment 420, machines 425 and home base station 440 (communicating with other user equipment 450 and machines (not shown)) may be a part of a secondary communication system to participate in, without limitation, device-to-device and machine-to-machine communications or other communications.

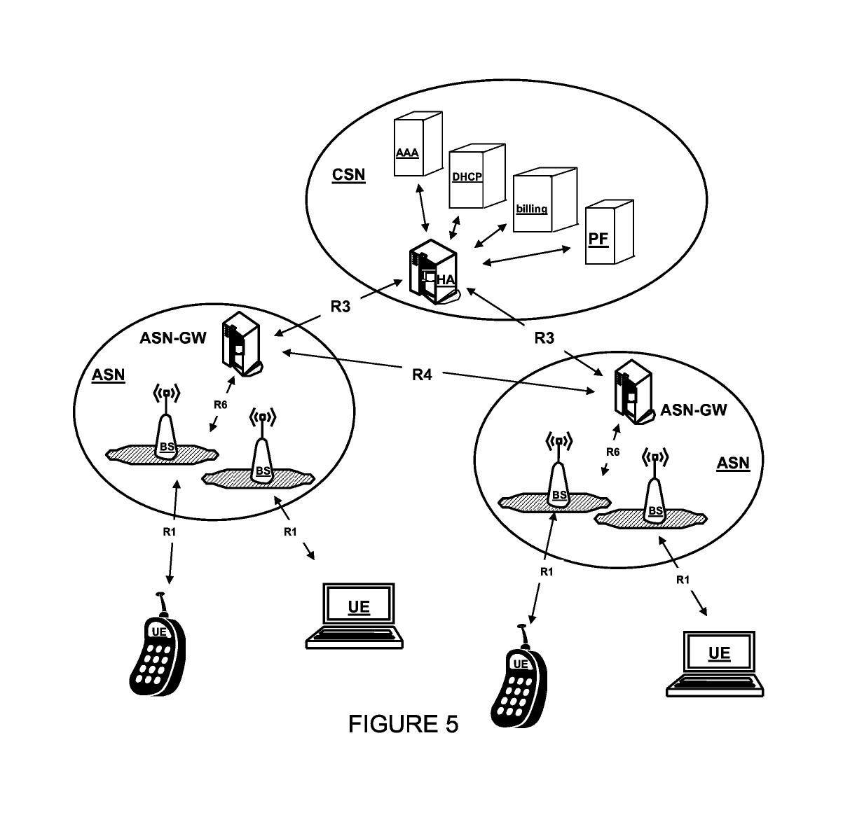

Turning now to FIG. 5, illustrated is a system level diagram of an embodiment of a communication system including a wireless communication system that provides an environment for the application of the principles of the present invention. The illustrated embodiment provides a communication system such as a WiMAX communication system typically configured according to IEEE standard 802.16. The WiMAX communication system includes a core service network (“CSN”) including a home access (“HA”) server. The core service network provides authentication, authorization, and accounting (“AAA”) functions via an AAA server, dynamic host configuration protocol (“DHCP”) functions via a DHCP server, billing functions via a billing server, and a policy function (“PF”) server. The AAA server validates user credentials, determines functions permissible under a given set of operating conditions and tracks network utilization for billing and other purposes. The DHCP server is used to retrieve network configuration information such as Internet protocol address assignments. The policy function server coordinates various network resources to provide requested services to authorized subscribers, and is responsible for identifying policy rules for a service that a subscriber may intend to use.

The WiMAX communication system further includes access service networks (“ASNs”) that include ASN gateways (ASN-GWs”) and base stations (“BSs”) that provide wireless communication with user equipment (“UE”). A home access server communicates with the access service networks over R3 interfaces, and the ASN-GWs communicate with other ASN-GWs over R4 interfaces. The ASN-GWs communicate with base stations over R6 interfaces. The base stations communicate with the user equipment over wireless R1 interfaces.

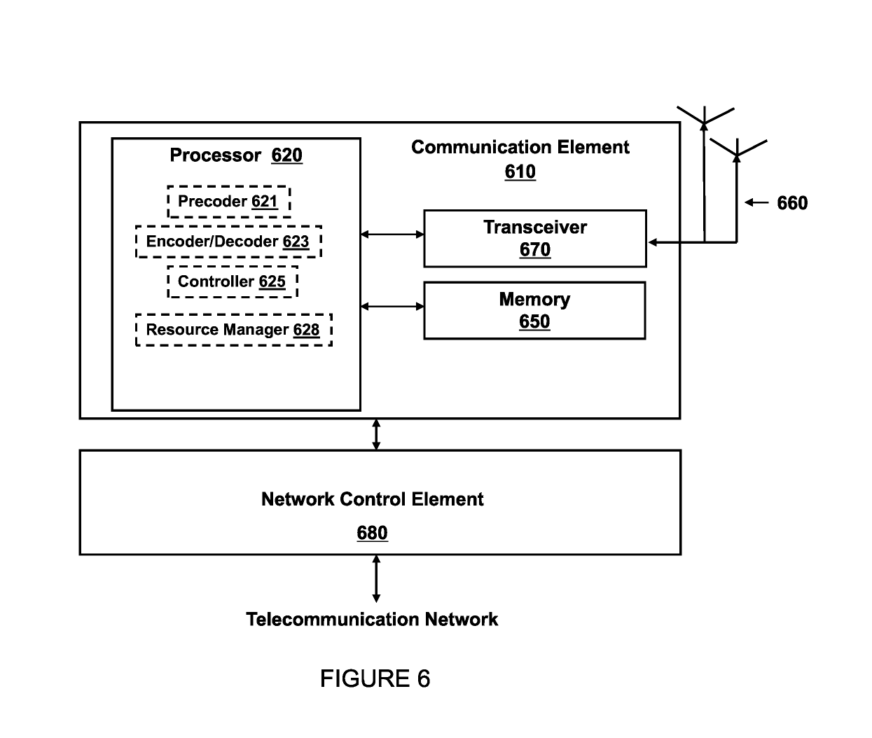

Turning now to FIG. 6, illustrated is a system level diagram of an embodiment of a communication element 610 of a communication system for application of the principles of the present invention. The communication element or device (or network element) 610 may represent, without limitation, a base station, a wireless communication device (e.g., a subscriber station, terminal, mobile station, user equipment, machine), a network control element, a communication node, or the like. The communication element 610 includes, at least, a processor 620, memory 650 that stores programs and data of a temporary or more permanent nature, an antenna 660, and a radio frequency transceiver 670 coupled to the antenna 660 and the processor 620 for bidirectional wireless communication. The communication element 610 may provide point-to-point and/or point-to-multipoint communication services.

The communication element 610, such as a base station in a cellular network, may be coupled to a communication network element, such as a network control element 680 of a public switched telecommunication network (“PSTN”). The network control element 680 may, in turn, be formed with a processor, memory, and other electronic elements (not shown). The network control element 680 generally provides access to a telecommunication network such as a PSTN. Access may be provided using fiber optic, coaxial, twisted pair, microwave communication, or similar link coupled to an appropriate link-terminating element. A communication element 610 formed as a wireless communication device is generally a self-contained device intended to be carried by an end user.

The processor 620 in the communication element 610, which may be implemented with one or a plurality of processing devices, performs functions associated with its operation including, without limitation, precoding of antenna gain/phase parameters (precoder 621), encoding and decoding (encoder/decoder 623) of individual bits forming a communication message, formatting of information, and overall control (controller 625) of the communication element 610, including processes related to management of communication resources (resource manager 628). Exemplary functions related to management of communication resources include, without limitation, hardware installation, traffic management, performance data analysis, tracking of end users and equipment, configuration management, end user administration, management of wireless communication devices, management of tariffs, subscriptions, security, billing and the like. For instance, in accordance with the memory 650, the resource manager 628 is configured to allocate communication resources (e.g., time and frequency communication resources) for transmission of voice communications and data to/from the communication element 610 and to format messages including the communication resources therefor in a communication system.

The execution of all or portions of particular functions or processes related to management of communication resources may be performed in equipment separate from and/or coupled to the communication element 610, with the results of such functions or processes communicated for execution to the communication element 610. The processor 620 of the communication element 610 may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The transceiver 670 of the communication element 610 modulates information on to a carrier waveform for transmission by the communication element 610 via the antenna(s) 660 to another communication element. The transceiver 670 demodulates information received via the antenna(s) 660 for further processing by other communication elements. The transceiver 670 is capable of supporting duplex operation for the communication element 610. It should be understood that the transceiver 670 may handle different types of communications (such as a cellular communication and a WLAN communication) or the communication element 610 may include multiple transceivers, wherein each transceiver handles a different type of communication.

The memory 650 of the communication element 610, as introduced above, may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 650 may include program instructions or computer program code that, when executed by an associated processor, enable the communication element 610 to perform tasks as described herein. Of course, the memory 650 may form a data buffer for data transmitted to and from the communication element 610. Exemplary embodiments of the system, subsystems, and modules as described herein may be implemented, at least in part, by computer software executable by processors of, for instance, the wireless communication device and the base station, or by hardware, or by combinations thereof. The systems, subsystems and modules may be embodied in the communication element 610 as illustrated and described herein.

When the communication element 610 is operable as a user equipment, the processor 620 in accordance with the memory 650 is configured to receive a beam-steering test configuration from a serving network element (e.g., a serving base station or access point) in response to a request for a beam-steering test with a network element (e.g., another base station or access point), and perform the beam-steering test with the network element in the beam-steering test configuration. The processor 620 in accordance with the memory 650 of the user equipment is configured to provide an indicator indicating the capability of the user equipment to perform the beam-steering test. The processor 620 in accordance with the memory 650 of the user equipment is also configured to provide a beam-steering constraint (e.g., a constraint to steer a beam by the user equipment, a constraint regarding a transmission power of the beam or a constraint for received signals by the user equipment) of the user equipment to the serving network element. The beam-steering test may be initiated by the user equipment in response to a beam-steering constraint detected by the user equipment or to resolve a communication conflict detected by the user equipment. The processor 620 in accordance with the memory 650 of the user equipment is still further configured to hand over the user equipment to the network element depending on a result of the beam-steering test.

When the communication element 610 is operable as a network element such as a base station (e.g., a serving base station or access point), the processor 620 in accordance with the memory 650 is configured to produce a beam-steering test configuration for a beam-steering test between a user equipment served by the serving base station and a network element (e.g., another base station or access point), and provide the beam-steering test configuration to the user equipment. The processor 620 in accordance with the memory 650 of the serving base station is configured to receive an indicator indicating the capability of the user equipment to perform the beam-steering test. The processor 620 in accordance with the memory 650 of the serving base station is configured to receive a beam-steering constraint from the user equipment. The processor 620 in accordance with the memory 650 of the serving base station is also configured to cause the serving base station to request the beam-steering test in response to a beam-steering constraint received from the user equipment or to resolve a communication conflict associated with the user equipment. The processor 620 in accordance with the memory 650 of the serving base station is further configured to perform a handover of the user equipment to the network element depending on a result of the beam-steering test.

As mentioned above, beam steering is a functionality for improvement of communication link capacity of high-throughput radios. Communication link capacity can be improved by reducing and avoiding distortions and disturbances caused by simultaneous transmissions between devices in a common geographical area.

Physical obstacles, beams from other communication devices, and interference produced internally by a communication device (e.g., a user equipment) can adversely affect the transmission or reception of a communication signal. The communication device may have internal means to resolve an interference issue. For instance, the communication device may stop transmitting or receiving a beam from another communication device (e.g., from a base station or an access point (“AP”)) in the direction of a person's detected head. For finding optimal beam-steering parameters, the communication device can include constraints in beam steering. A network element can advantageously use the informed constraints, for example, to hand over the communication device to another network element (e.g., another base station or access point) with which the communication device does not have the previously determined constraints. The network element may assist the communication device to discover constraints by enabling beam-steering measurements with the communication device.

As introduced herein, signaling between a communication device and another communication device is performed to enable efficient beam steering. The another communication device can perform beam steering more effectively if it knows preferred and/or non-preferred directions to and from the communication device. Signaling between a communication device and another communication device may also be performed to support testing of beam-steering directions or beam-steering configuration patterns. Present beam steering and sounding operations do not include constraints of another (e.g., neighboring or nearby) communication devices or the proximity of the user's head on beam steering. However, such constraints are often present for communication between the communication device and another communication device such as a network element.

A communication device may have known constraints for beam steering. For instance, the communication device may be able to determine that it cannot transmit in a specific direction because there is a collocated radio in the communication device operating on the same or an adjacent frequency that blocks communication in that direction. Also, the communication device may have detected an external obstacle. As an example, a user's head may have been detected adjacent the communication device by employing a proximity sensor or another means of detecting the communication device's position or movement. Additionally, other radio communication devices or physical obstacles may have been detected in various databases that reference the location of the communication device. A network element may discover other communication devices or physical obstacles from a database, and use the beam-steering constraints to provide a beam-steering test configuration to the communication device. Various location-based databases and applications are expected to increase in the future due to white-space regulations and cognitive radio operation. Google® and Ovi® maps provide examples of location-based databases. Both of these databases contain information of buildings that may obstruct a communication path. In the future, there may be other databases that can be used for efficient spectrum sharing and coexistence. Such databases could also contain information providing radio communication device locations and radiation patterns. In these cases, the communication device may avoid certain directions when transmitting or receiving a beam. If the communication device is able to inform another communication device about its beam-steering constraints or the another communication device is able to determine the beam-steering constraints, transmission may still be able to continue with a different network element.

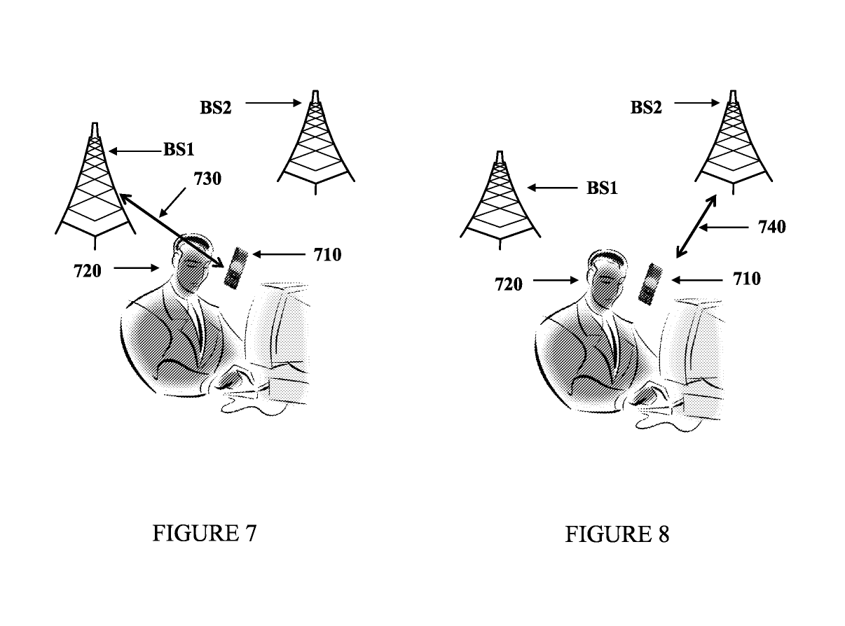

Turning now to FIGS. 7 and 8, illustrated are representations of an embodiment of a user equipment 710 communicating with a network element (e.g., a serving base station BS1) that results in a handover of the user equipment 710 to another network element (e.g., another base station BS2) after communication of a beam-steering constraint in accordance with the principles of the present invention. The user equipment 710 is connected to the serving base station BS1 over a radio pathway or communication link 730 in a communication system. A user's head 720 is in the radio pathway 730 between the user equipment 710 and the serving base station BS1, thereby possibly absorbing a substantial level of radio frequency energy radiated by the user equipment 710. Thus, the radio pathway 730 is not a preferred direction of transmission for the user equipment 710. The user equipment 710 transmits a beam-steering constraint to the serving base station BS1, and the serving base station BS1 is informed that there are constraints concerning the radio pathway 730 between the serving base station BS1 and the user equipment 710.

The serving base station BS1 evaluates the beam steering constraints of the user equipment 710, and identifies the another base station BS2 that can successfully communicate with the user equipment 710 without the need for the user equipment 710 to direct its beam through the user's head 720. Of course, the evaluation by the serving base station BS1 may be performed by another network element in the communication system.

As illustrated in FIG. 8, the user equipment 710 has now been handed over to the another base station BS2. The radio pathway or communication link 740 of the radiated beam of the user equipment 710 is now no longer directed at the user's head 720, thereby reducing the user's specific absorption rate while providing a useful communication path for the user equipment 710 to the communication system.

A communication device may detect interference in its beam transmissions and/or receptions, and it may be advantageous to test other beam-steering options with another communication device. The device may be able to discover interference in its communication pathways, but it may not be able to accurately determine all the beam-steering constraints. To be able to find a better option for beam steering for data transmission and reception, the device may have to perform beam-steering measurements. The beam-steering measurements can be performed with the another communication device such as another network element.

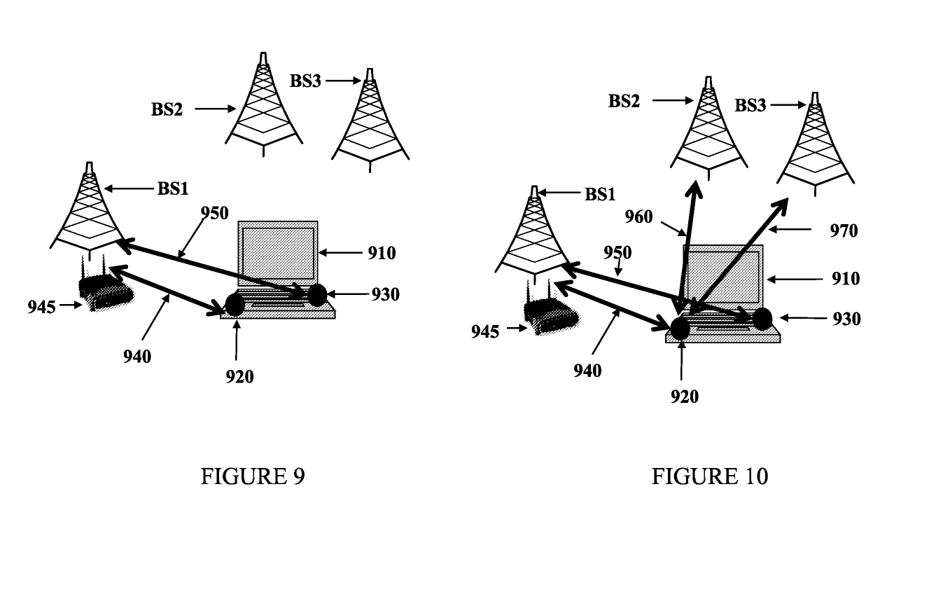

Turning now to FIGS. 9 and 10, illustrated are representations of an embodiment of a user equipment 910 communicating with a serving network element (e.g., a serving base station BS1) to a perform beam-steering test in accordance with a beam-steering test configuration according to the principles of the present invention. The user equipment 910 is fitted with two internal radios or transceivers (a first internal radio 920 and a second internal radio 930) that communicate with the serving base station BS1 over radio pathways or communication links 940, 950 with poor quality (e.g., with poor channel quality indicators (“CQIs”)) because radio pathways 940, 950 interfere with each other. It should also be noted that the first and second internal radios 920, 930 may be connected to different communication systems that provide interference (e.g., due to internal interferences, adjacent channel interferences or harmonized frequency interferences). In such a case, the first internal radio 920 may be connected to an access point 945 and the second internal radio 930 may connected to the serving base station BS1.

The user equipment 910 requests a beam-steering test mode from the serving base station BS1 (or the access point 945) to which it is connected. The communication system configures other network elements (a second and third base station BS2, BS3) to participate in the beam-steering tests and informs the user equipment 910 about the beam-steering test configuration. The user equipment 910 transmits and receives test beams 960, 970 to and from the second and third base stations BS2, BS3, respectively, to find an improved beam-steering arrangement for the first internal radio 920. If a communication link with the second or third base station BS2, BS3 is better than with the serving base station BS1, the communication system (in cooperation with the serving base station BS1 and user equipment 910) may initiate a handover.

For efficient operation and testing of beam steering, a user equipment employs the support from the communication system including another communication device. Peer/network-assisted operations and network operations in selecting suitable directions and patterns for beam forming or testing to find an appropriate direction would resolve an unanswered need for further improvement in communication systems.

As introduced herein, a process is employed for signaling another communication device to test and select an efficient beam configuration for a communication device with support of the communication system. The communication device can signal its beam-steering capabilities (e.g., whether beam steering selection and testing is supported and enabled) and/or its beam-steering constraints (e.g., in which direction or directions the device cannot or does not prefer to transmit, or from which direction or directions the device cannot receive properly). In accordance therewith, a reason can be given for the beam-steering capabilities or constraints.

The communication device can signal its capabilities to test beam steering with another communication device (such as a base station or access point). For testing beam-steering or beam-pattern combinations with another communication device, a communication device may signal that the device can test combinations of beam forming with two or more communication device internal radios or transceivers when at least one communication link is a point-to-point link with another communication device. The communication device may signal testing of beam steering in a communication system with multiple base stations/access points. Feedback may be important from the another communication device so that the communication device can identify whether transmissions are corrupted. Accordingly, test signals from the another communication device may be important for the communication device to test reception. When setting up a connection, the communication device and the another communication device can signal their respective capabilities to support beam-steering features. As an example, field values of 1=yes or 0=no can be signaled. If a signaling frame does not exist or is not transmitted, the communication device can be assumed not to support the feature.

As another example, support for a beam-steering constraint frame fields can be signaled. The communication device can signal receiving a beam-steering constraint to indicate the device is able to receive a beam-steering constraint. The communication device can signal transmitting a beam-steering constraint to indicate the device is able to transmit constraint information. Optionally, the communication device can signal which constraint or constraints the device can take into account in beam steering. It will be understood herein that beam steering can include beam forming. The communication device can signal beam-steering test mode frame fields. For example, the communication device can signal that it can perform point-to-point tests, and whether such testing is limited to only one other communication device.

The communication device can signal network tests, and what testing is supported with other network elements. The supported test signals (which can be many) can signal what test signals the communication device is able to receive and/or transmit. The supported feedback signals (which can be many) can signal what feedback information the communication device is able to provide or process.

In addition to exchanging capabilities between the communication device and another communication device, the other party may also need to signal and enable the modes that can be used in the beam-steering test exchange. As an example, the network's capability to process and support a beam-steering constraint or test modes may depend on a network load (e.g., the number of communication devices the base stations or access point is supporting). Exemplary response field values in the link are 1=enable, 0=disable beam-steering constraint modes. Other exemplary enabling response field values related to beam steering include a beam-steering transmission constraint for enabling or disabling another communication device to transmit a beam-steering constraint, point-to-point test information for enabling/disabling point-to-point tests, and network test information for enabling/disabling network tests. An alternative for test enablement may be that the communication device requests the aforementioned separately.

A communication device can signal beam-steering constraint parameters related to testing. If another communication device supports receiving and has enabled transmissions of a beam-steering constraint, the communication device that has a constraint may signal the constraint to the another communication device. If the communication device has multiple transmission and/or reception constraints, it may signal them separately with multiple fields. Examples of transmission constraints include, without limitation, a transmission constraint type to signal that the communication device has transmission constraints, a constraint direction indicating a constraint azimuthal direction (e.g., 0=north, 180=south), an angular range around the direction where the constraint is valid, constraint severity to signal a transmission not allowed, an equivalent isotropically radiated power (“EIRP”) limitation and value, a constraint reason (such as not known, device internal, person in vicinity, or other external obstacle), constraint validity (such as not known, short term, long term), constraint frequencies (to signal that channels that are constrained), and constraint signal coding (to signal coding modes that are constrained). Examples of reception constraints include, without limitation, reception constraint type (to signal reception constraints), constraint direction (given as an azimuthal angle), azimuthal constraint range (to signal the angular range around the azimuthal direction where the constraint is valid), constraint severity (to signal that reception is not possible), transceiver sensitivity and value, constraint reason (to signal not known, device internal, person in vicinity, or other external obstacle), constraint validity (to indicate not known, short term, long term), constraint frequencies (to signal channels that are constrained), and constraint in signal coding (to signal coding modes that are constrained).

After the other communication device receives a beam-steering constraint, it may use the information to reconfigure the communication link with the signaling device. As an example, the other communication device may use a different antenna pattern or channel for beam forming. As another example, the network element may determine a base station/access point with which the communication device would not have constraints. The network element may hand over the communication device to another base station or access point, or provide information of the another base station or access point (e.g., base station or access point identification (“ID”), direction/location, credentials) to the communication device so that the device may initiate the handover itself. (See, e.g., FIGS. 7 to 10 and the related description thereof.)

Beam-steering testing with another communication device can be performed. If the other communication device supports a test mode (and its use is enabled), the device may request beam-steering testing (e.g., to discover communication parameters or a communication link with better quality such as a channel quality indicator for the device). A communication device may, for example, use beam-steering testing to test connections to different communication devices including different base stations/access points, and select a better combination.

In an embodiment, point-to-point testing of beam-steering combinations is performed. An exemplary scenario of such a testing is a communication device that wishes to test best or improved transmission and/or reception combinations for beam steering if it has two or more internal device radios. The tests can be performed with one or more other communication devices depending on whether the other communication devices support the subject beam-steering test modes. Also, the communication device may suffer from some external interference and may wish to test if some other transmission or reception parameters are better.

A communication device requesting or responding to a test mode request may set parameters for the test. For example, a transmission test signal that another communication device transmits can define test signal parameters or can select from a list of predefined test signals. Such signals may include reception test signals for another communication device to receive from the communication device requesting the test. As examples, without limitation, such test signals may include requested feedback information (i.e., what information another communication device should provide as feedback), the effective isotropic radiated power (“EIRP”) for a transmission signal, what EIRP the other communication device should use, power information for the test, EIRP for the received signal, EIRP for the communication device to transmit, transmission direction and angle, reception direction and angle, transmission test frequencies (can include a pattern), reception test frequencies (can include a pattern), signal interval, and test duration.

After requesting and agreeing on test parameters, the communication devices enter the test mode. The test may be ended by requesting an ending, or the duration may be defined when setting up the beam-steering test mode. If a better configuration is discovered with the tests, a new configuration and/or other communication devices on the same or neighboring frequencies may be taken in use, which can improve device coexistence and data throughput. A network with multiple base stations/access points can employ beam-steering direction testing. A communication device may wish to test beam steering with other base stations/access points of the communication system. If the network supports and is enabled for a network test mode, the communication device may request the test mode with the network. If the network discovers problems with a communication link, the base stations/access points may request the test mode.

A communication device may request a test with certain parameters (e.g., it may only wish to test in a specific direction with base stations/access points). Similar parameters as indicated above may also be set. With a network test, the network configures the beam-steering test mode for the base stations/access points that participate in the test. The network informs the participating base stations/access points the direction for which they are to perform the beam transmission and reception test, as well as other parameters that will be used with the test. In addition, the network (base station/access point with which the device is associated) inform the device about the beam-steering test configuration, including, for example, azimuthal directions, and when to transmit or receive. Example of beam-steering testing is illustrated in and described previously hereinabove with reference to FIGS. 9 and 10, wherein multiple base stations/access points were selected for beam-steering testing for the user equipment. Note that in cognitive radio communication systems, a user equipment or base station may initiate a handover to another system as well, based on beam-steering measurement results.

Beam-steering testing processes introduced herein can provide improved communication throughput and more efficient operation over current practice. This can result in fewer retransmissions by a base station or user equipment, and possibly lower transmission power. This can also result in improved network management. For example, a handover of a user equipment to another base station can enable continuation of transmissions that might not be possible with an original base station. This can result in enhanced coexistence, both in-device and with other spectrum user equipment.

Thus, as introduced herein, directed beams for testing are employed with a serving or a nearby base station or access point. A user equipment requests from its serving base station/access point a directed beam test mode with another base station/access point. Alternatively, a serving base station/access point can direct a user equipment to employ a directed-beam test mode with another base station/access point due to poor channel quality between the user equipment and the serving base station/access point. A serving base station/access point (or a network element) requests (over a backhaul communication path) nearby base station/access point(s) to participate in a directed beam test-mode with a user equipment. The request may contain information of a user equipment that enables the nearby base station/access point to send directed test beams to the user equipment (e.g., the location of the user equipment).

Upon receiving a request, the nearby base station/access point (or network element) responds whether it will participate or not in the directed-beam test mode with the user equipment. The response contains information of the beam-steering test configuration (e.g., schedule and frequency) so that the user equipment would know when, with what signals, from/to what direction, and what frequency to receive/transmit directed-beam test signals. If the response from the nearby base station/access point above is positive, the serving base station/access point sends the beam-steering test configuration to the user equipment (which requested the test mode with another base station/access point or which is otherwise directed to the test mode that was initially described).

The user equipment enters in the test mode with the other base station/access point. In the test mode, both the base station/access point and user equipment may transmit specific signals to each other to test a directed channel between them (e.g., employing a reference signal). After the test mode with one or more neighboring base station/access points, the user equipment may request/perform handover of beams with the other base station/access point if the resulting communication link is of better quality. Alternatively, the serving base station may have collected information on the tests (from the participating base station/access point and/or user equipment) and may initiate the handover itself.

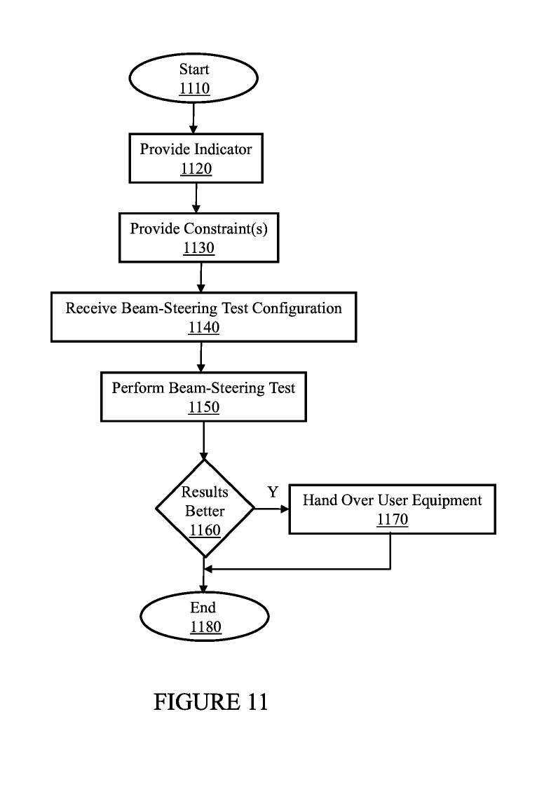

Turning now to FIG. 11, illustrated is a flow diagram of an embodiment of operating a user equipment (a communication device) according to the principles of the present invention. The method begins in a step or module 1110. In a step or module 1120, the user equipment provides an indicator indicating the capability of the user equipment to perform a beam-steering test. In accordance therewith, the user equipment provides a beam-steering constraint of the user equipment to a serving network element (e.g., a serving base station) in a step or module 1130. The beam-steering constraint may include, without limitation, a constraint to steer a beam by the user equipment, a constraint regarding a transmission power of the beam or a constraint for received signals by the user equipment.

In a step or module 1140, the user equipment receives a beam-steering test configuration from the serving network element in response to a request for a beam-steering test for a user equipment with a network element (e.g., another base station). The request for the beam-steering test may be initiated by the user equipment. In accordance therewith, the request for the beam-steering test may be initiated by the user equipment in response to a beam-steering constraint (associated with the user equipment or network element(s)) detected by the user equipment or to resolve a communication conflict detected by the user equipment.

In a step or module 1150, the user equipment performs the beam-steering test with the network element in the beam-steering test configuration. In a decisional step or module 1160, it is determined if the results of the beam-steering test are better for the network element. If the results are better, then the user equipment may be handed over to the network element in a step or module 1170, and thereafter the method ends in a step or module 1180. Otherwise, the method ends in the step or module 1180. While the aforementioned method was illustrated and described with respect to one network element, the beam-steering test using the beam-steering test configuration can be employed with a plurality of network elements (e.g., a plurality of other base stations). Accordingly, the user equipment may be handed over to any one of the plurality of network elements depending on the results of the beam-steering test(s) in a step or module 1160. Additionally, the beam-steering test configuration(s) may vary with respect to the plurality of network elements.

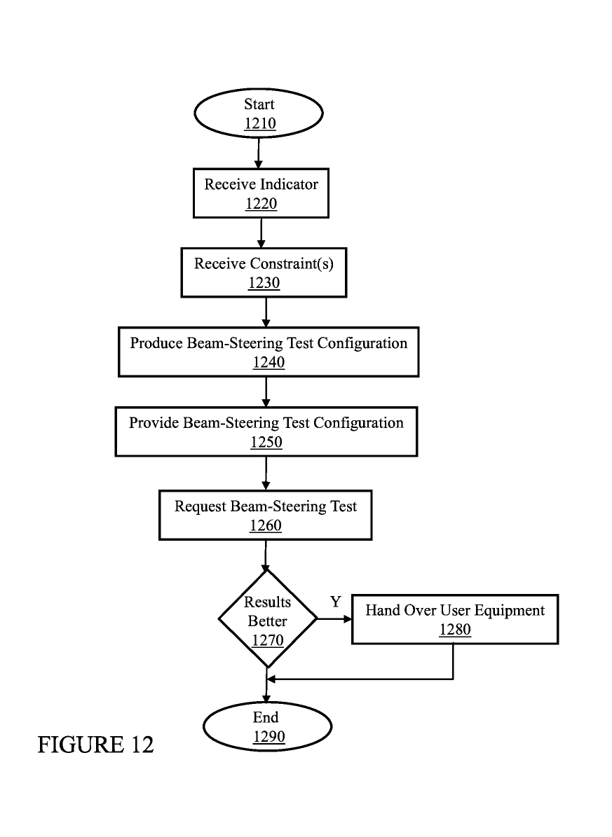

Turning now to FIG. 12, illustrated is a flow diagram of an embodiment of operating a serving network element (e.g., a serving base station) according to the principles of the present invention. The method begins in a step or module 1210. In a step or module 1220, the serving network element receives an indicator indicating the capability of a user equipment to perform a beam-steering test. In a step or module 1230, the serving network element receives a beam-steering constraint from the user equipment. The beam-steering constraint may include, without limitation, a constraint to steer a beam by the user equipment, a constraint regarding a transmission power of the beam or a constraint for received signals by the user equipment.

The serving network element thereafter produces a beam-steering test configuration for the beam-steering test between the user equipment served by the serving network element and a network element (e.g., another base station) in a step or module 1240. The serving network element then provides the beam-steering test configuration to the user equipment in a step or module 1250. In a step or module 1260, the serving network element requests that the user equipment perform the said beam-steering test with the network element. The request may be initiated in response to a beam-steering constraint (associated with the user equipment or network element(s)) received from the user equipment or to resolve a communication conflict associated with the user equipment.

In a decisional step or module 1270, it is determined if the results of the beam-steering test are better for the network element. If the results are better, then the user equipment may be handed over to the network element in a step or module 1280, and thereafter the method ends in a step or module 1290. Otherwise, the method ends in the step or module 1290. While the aforementioned method was illustrated and described with respect to one network element, the beam-steering test using the beam-steering test configuration can be employed with a plurality of network elements (e.g., a plurality of other base stations). Accordingly, the user equipment may be handed over to any one of the plurality of network elements depending on the results of the beam-steering test(s) in a step or module 1270. Additionally, the beam-steering test configuration(s) may vary with respect to the plurality of network elements.

Program or code segments making up the various embodiments of the present invention may be stored in a computer readable medium or transmitted by a computer data signal embodied in a carrier wave, or a signal modulated by a carrier, over a transmission medium. For instance, a computer program product including a program code stored in a computer readable medium (e.g., a non-transitory computer readable medium) may form various embodiments of the present invention. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network communication channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-40. (canceled)

41. An apparatus, comprising:
a processor; and
memory including computer program code,
said memory and said computer program code configured to, with said processor, cause said apparatus at least to:
receive a beam-steering test configuration from a serving network element in response to a request for a beam-steering test with a network element; and
perform said beam-steering test with said network element in said beam-steering test configuration.

42. The apparatus as recited in claim 41 wherein said memory and said computer program code are further configured to, with said processor, cause said apparatus to provide an indicator indicating the capability of said apparatus to perform said beam-steering test.

43. The apparatus as recited in claim 41 wherein said memory and said computer program code are further configured to, with said processor, cause said apparatus to provide a beam-steering constraint of said apparatus to said serving network element.

44. The apparatus as recited in claim 43 wherein said beam-steering constraint comprises a constraint to steer a beam by said apparatus, a constraint regarding a transmission power of said beam or a constraint for received signals by said apparatus.

45. The apparatus as recited in claim 41 wherein said request for said beam-steering test is initiated by said apparatus in response to a beam-steering constraint detected by said apparatus.

46. The apparatus as recited in claim 41 wherein said request for said beam-steering test is initiated by said apparatus to resolve a communication conflict detected by said apparatus.

47. The apparatus as recited in claim 41 wherein said memory and said computer program code are further configured to, with said processor, cause said apparatus to hand over to said network element depending on a result of said beam-steering test.

48. A computer program product comprising a computer-readable medium bearing computer program code embodied therein for use with a computer, the computer program code includes code for:
receiving a beam-steering test configuration from a serving network element in response to a request for a beam-steering test for a user equipment with a network element; and
performing said beam-steering test with said network element in said beam-steering test configuration.

49. A method, comprising:
producing a beam-steering test configuration for a beam-steering test between a user equipment served by a serving network element and a network element; and
providing said beam-steering test configuration to said user equipment.

50. The method as recited in claim 49 further comprising receiving an indicator indicating the capability of said user equipment to perform said beam-steering test.

51. The method as recited in claim 49 further comprising receiving a beam-steering constraint from said user equipment.

52. The method as recited in claim 49 further comprising requesting said beam-steering test.

53. The method as recited in claim 52 wherein said request is initiated in response to a beam-steering constraint received from said user equipment.

54. The method as recited in claim 52 wherein said request is initiated to resolve a communication conflict associated with said user equipment.

55. The method as recited in claim 49 further comprising performing a handover of said user equipment to said network element depending on a result of said beam-steering test.
